(19) United States
(12) Patent Application Publication
(10) Pub. No.: US 2012/0031934 A1
(43) Pub. Date: Feb. 9, 2012

(54) UNIVERSAL SPARE TIRE AND ACCESSORY MOUNT

(76) Inventor: ALEX DANZE, RIVERSIDE, CA (US)

(21) Appl. No.: 12/851,949

(22) Filed: Aug. 6, 2010

(51) Int. Cl. B62D 43/00

(52) U.S. Cl. 224/42.12

(57) ABSTRACT

Improvements in a universal spare tire and accessory mount that includes a tire jack that is secured to an enlarged foot base to provide a larger lifting area to distribute the load from a jack onto the ground to prevent the jack from sinking into soft terrain, sand or mud. The mount secures to a vehicle or trailer to hold a spare tire and further includes tie down to secure the mount and the spare tire. The mount has storage or mounting features to provide additional storage of tools, accessories and or supplies. The mount can be secured to various parts of a vehicle or trailer including the bumper, hood, bed, floor or trunk of the vehicle.

### CROSS REFERENCE TO RELATED APPLICATION

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in a universal spare tire accessory mount. More particularly, the present application provides for mounting of a spare tire on an ATV, car, truck, trailer or similar vehicle. It incorporates an accessory mount and an enlarged foot base to enhance lifting a vehicle on soft surfaces such as sand or mud.

2. Description of Related Art including information disclosed under 37 CFR 1.97 and 1.98

Several products and patents are available and have issued that provide some of the features that are disclosed and claimed in this application. Exemplary examples of patents covering these products are disclosed herein.

U.S. Pat. No. 1,589,770 issued May 5, 1924 to C. Trigg and U.S. Pat. No. 7,036,697 issued May 2, 2006 to John Hwang et al., both disclose tool storage kits where the tools are stored within the cavity of a spare tire. While these storage kits provide a place to store tools the storage area is does not include a tire jack, the storage area does not provide for an enlarged foot to provide a larger lifting area to distribute the load from a jack and these patents further do not provide tie downs to hold the spare tire onto a recreational vehicle.

U.S. Pat. No. 4,174,797 issued Nov. 20, 1979 to Sersuo Yasue et and U.S. Pat. No. 4,498,614 issued Feb. 12, 1985 to David Guarr both disclose storage or holding apparatus for a spare tire. In Guarr the spare tire is bolted to a vehicle using the mounting holes that mount the tire to an axle. In Yasue et al the spare tire is hinged under the vehicle for storage. While these patents provide mounting and storage of a spare tire, they do not include a tire jack and the storage area does not provide for an enlarged foot to provide a larger lifting area to distribute the load from a jack in soft terrain.

U.S. Pat. No. 4,021,018 issued May 3, 1977 to Velu K, K, Dasan and publication number US 2009/0047108 that was published on Feb. 19, 2009 to Mark R. Barie et al both disclose vehicle jacking devices. In the case of Dasan the jack lifts from the center of a tire shaped device. In the case of Barie et al, the jack is integrated with the spare tire lift. In the application of Barie et al., the jack is removable from a frame to jack a vehicle to change a tire. While these jacks provide a lifting means for a vehicle, they do not provide a storage area and further do not provide tie downs to hold the spare tire onto the hood if vehicles or trailers.

What is needed is a universal spare tire mount that allows vehicles and trailers to accept a spare tire integrated with a jack. The mount further should provide for storage of tools and an enlarged footprint to allow the jack to lift a vehicle on soft ground.

### BRIEF SUMMARY OF THE INVENTION

It is an object of the universal spare tire and accessory mount for the mount to be configured in a number of methods that allows the mount to be secured to a vehicle in a number of locations and orientations. The mount can be secured onto a vertical surface such as a bumper, tailgate vertical bed or can be secured onto a horizontal surface such as a hood or trunk without reducing the ground clearance of intruding into the passenger compartment of the vehicle.

It is an object of the universal spare tire and accessory mount to include mounting apparatus for a spare tire where the spare tire is held down by the accessory mount. In most recreational vehicles like UTV's they are not provided with a spare tire. Because of the terrain that the vehicle is often traversing there is a high potential for the vehicle of get a flat tire and the operator must nurse the vehicle back to where the tire can be changed. The universal spare tire and accessory mount can also be configured to mount onto trucks and or trailers.

It is another object of the universal spare tire and accessory mount to include a vehicle jack. The vehicle jack allows a person to lift the vehicle to change a tire. The jack is provided on an enlarged foot base that both distributes the ground load over an enlarged area and provides support directly under the column of the jack to evenly distribute the lifted weight. The enlarged foot enables the jack to lift a heavy load on a soft surface such as sand or mud without the jack sinking into the ground.

It is another object of the universal spare tire and accessory mount to include tie down locations. The tie downs allow a user to secure additional items onto the vehicle. The tie down can also secure the mount onto the recreational vehicle. The tie down can be provided with a number of configurations to hold a shovel, fuel, a cooler or first aid kit and countless other accessories.

It is still another object of the universal spare tire and accessory mount to provide a storage area for tools. The tools can include but are not limited to securing straps, screw driver(s), wrenches, wire, tape and spare parts. Often recreational vehicles are supplied with minimal or limited tools and further have limited storage areas. The accessory mount provides for storage of these accessories outside of the passenger compartment of the recreational vehicle.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a perspective view of the universal spare tire and accessory mount on a flat surface.

FIG. 2 shows a perspective view of the universal spare tire and accessory mount for mounting on a wall.

FIG. 3 shows a perspective view of the universal spare tire and accessory mount for mounting on a trailer tongue or similar surface.

FIG. 4 shows the universal spare tire and accessory mount with the mounting components.

FIG. 5 shows a front view of the universal spare tire and accessory mount that is mounted vertically.

FIG. 6 shows a back perspective view of the universal spare tire and accessory mount configured for a vertical mounting.

### DETAILED DESCRIPTION OF THE INVENTION

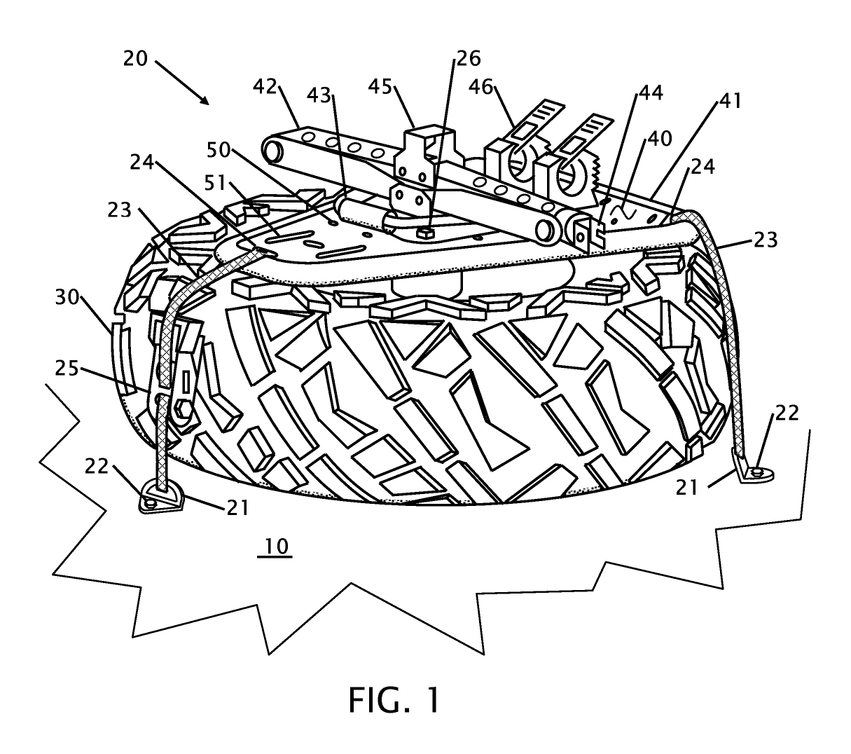

FIG. 1 shows a perspective view of the universal spare tire and accessory mount on 20 on a hood or trunk 10. The universal spare tire and accessory mount is configurable to mount in a variety of orientations and on a variety of surfaces. Because recreational vehicles such as all-terrain vehicles, that are commonly called ATV's quads or UTVs, four wheelers, sand rails, dune buggies or other names, are usually sold without spare tires, tire changing kits or even provide a location for a spare tire the universal spare tire and accessory mount provides a mounting surface that retains a spare tire 30 and the tools that are required to change the tire.

In the embodiment shown the universal spare tire and accessory mount 20 is secured to a flat surface such but not limited to the floor, truck bed, cargo rack or the hood or trunk of the all-terrain vehicle 10. In this embodiment a plurality of anchors 21. While two anchors are shown, in the preferred embodiment in is contemplated that three or more anchors are used to secure the spare tire 30 in a flat orientation. The anchors 21 are shown bolted 22 onto the vehicle 10. Nylon or similar straps 23 such as nylon, silk, cotton, polyester or a combination thereof connects from the anchors 21 through securing holes 24 in the universal spare tire and accessory mount 20. A ratchet buckle 25 is used to tighten the strap(s) 23 thereby sandwiching the spare tire 30 onto the vehicle 10.

In the preferred embodiment the universal spare tire and accessory mount 20 is configured in a semi triangular shape that forms a foot base 40. The foot base 40 is essentially a flat plate with a tubular outer frame 41. The tubular frame 41 is round or square in cross section. The flat plate is formed to leave voids in the outer three corners to allow the straps 23 to extend through the voids to secure the tire 30. A jack 42 is secured onto the foot base 40 with bolts 26 or the like. The foot base increases the surface area to more evenly distribute the lifting area of the jack when the jack is used on soft surfaces such as mud or sand were the jack 42 might normally sink without lifting the recreational vehicle. While the foot base 40 is shown in a triangular configuration other shapes and sizes are contemplated including but not limited to round, square, pentagonal and octagonal. In the configuration shown, the jack is a simple scissor jack 42, but other types of jacks are contemplated such as a hydraulic bottle type. The jack 42 secures the lifting crank 43. The lifting crank is placed into the receiver 44 of the jack and turned to extend the top pad 45 of the jack that is placed under the vehicle that is being lifted.

A pair of universal clamps 46 is shown mounted on top of the foot base 40. The universal clamps 46 are used to secure a shovel or other equipment or accessories that might be required to air is jacking the vehicle to change a tire 30. The plate of the foot base 40 has a plurality of holes 50 and slots 51 to secure the jack 42, clamps 46 and other equipment.

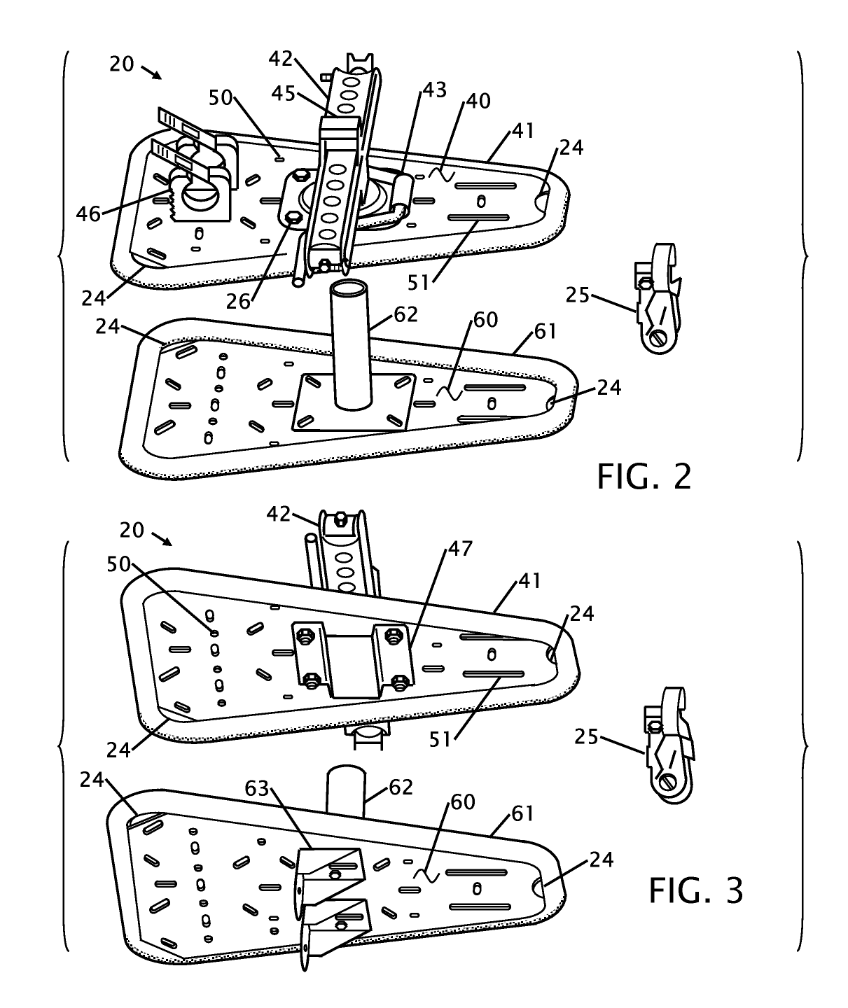

FIG. 2 shows a perspective view of the universal spare tire and accessory mount for mounting on a wall, and FIG. 3 shows a perspective view of the universal spare tire and accessory mount for mounting on a trailer tongue or similar surface. Both of these figures show the universal spare tire and accessory mount 20 with the foot base 40 welded or otherwise secured to an outer tubular frame 41. The foot base 40 shows a plurality of openings 24 for securing the universal spare tire and accessory mount 20. In both of these figures the universal spare tire and accessory mount includes both an upper foot base 40 and a lower foot base 60 where a spare tire (not shown) is placed between the feet 40, 60. Both the upper 40 and lower foot base 60 are essentially the same with a central plate that is secured to an outer tube 41, 61. When the tire is placed onto the universal spare tire and accessory mount 20, the tire is placed over the center post 62.

The foot base 40 has a jack 42 that is bolted 26 to the foot base 40 and the lifting crank 43 is shown held down by the jack 42. A series of holes 50 and slots 51 are used to secure the jack 42, universal clamps 46 and other hardware. The top of the jack 42 has a top pad 45 that makes contact with the lifting point of the recreational vehicle. A ratchet buckle 25 is shown. The ratchet buckle is used with straps that pass through the securing holes 24 to pull the upper 40 and the lower 60 feet together with a tire (not shown) placed between the feet.

FIG. 3 includes a plurality of brackets 63 that allow the universal spare tire and accessory mount 20 to be mounted on a trailer tongue or similar structure. The underside of foot base 40 has an inner cap 47 that is constructed at the same elevation as the outer tube 41. The inner cap 47 prevents bending of the center of the foot base by distributing the load from the jack 42.

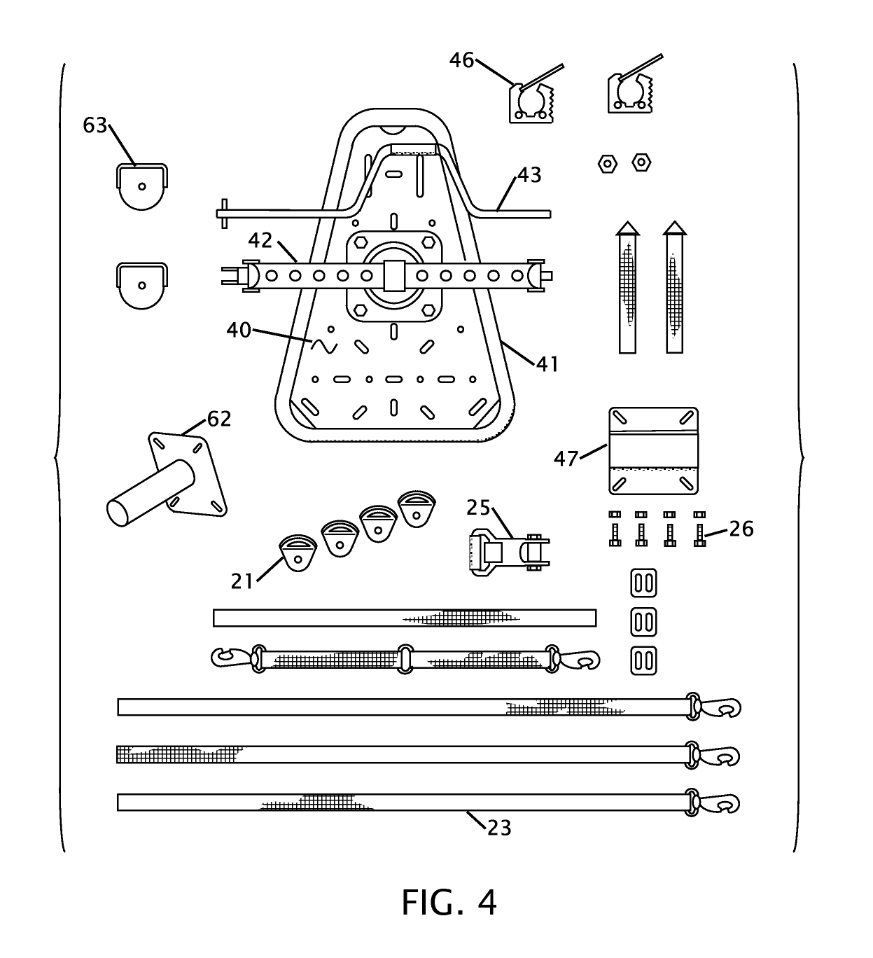

FIG. 4 shows the universal spare tire and accessory mount with the mounting components. Including the anchors 21, various straps 23, buckles, and ratchet buckles 25, bolts 26, nuts, foot base 40, tubular outer frame 41, jack 42, lifting crank 43, universal clamp 46, inner cap 47, center post 62 and brackets 63. While these items are shown and identified various other configurations and anticipated variations are contemplated.

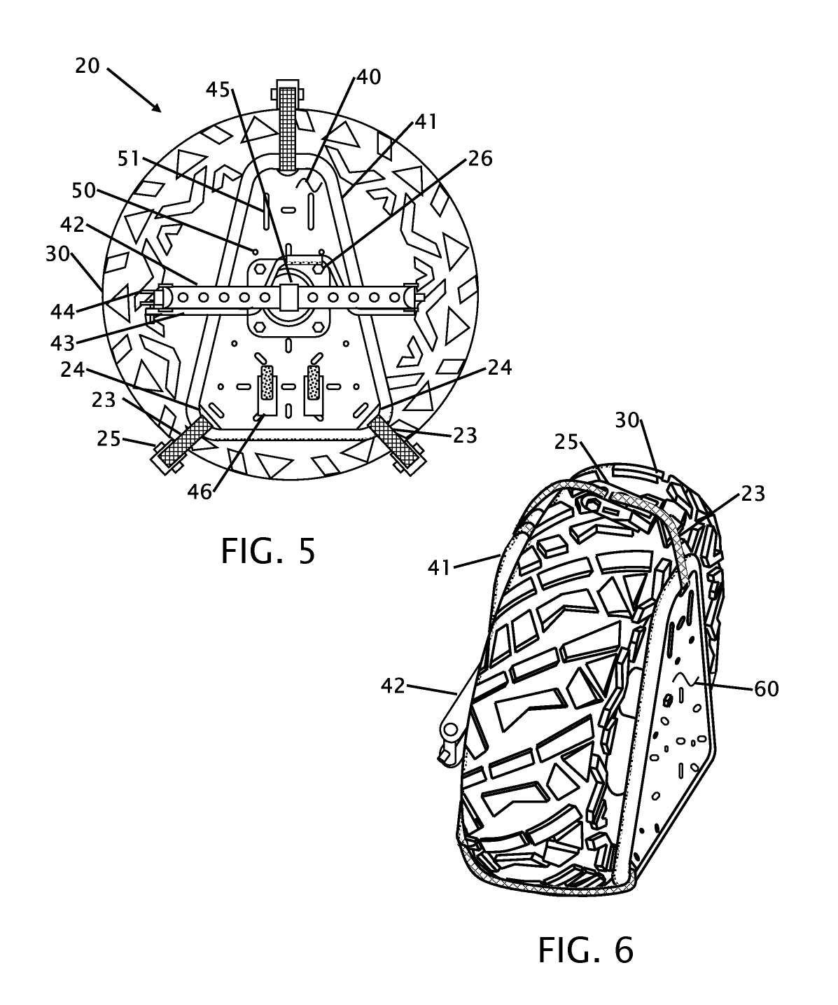

FIG. 5 shows a front view of the universal spare tire and accessory mount that is mounted vertically and FIG. 6 shows a back perspective view of the universal spare tire and accessory mount configured for a vertical mounting. In the embodiment shown the universal spare tire and accessory mount 20 is secured to a vertical surface. A ratchet buckle 25 is used to tighten the strap(s) 23 thereby sandwiching the spare tire 30.

In this preferred embodiment the universal spare tire and accessory mount 20 is configured in a semi triangular shape that forms a foot base 40. The foot base 40 is essentially a flat plate with a tubular outer frame 41. The flat plate is formed to leave voids in the outer three corners to allow the straps 23 to extend through the voids to secure the tire 30. A jack 42 is secured onto the foot base 40 with bolts 26 or the like. The foot base increases the surface area to more evenly distribute the lifting area of the jack when the jack is used on soft surfaces such as mud or sand were the jack 42 might normally sink without lifting the recreational vehicle. While the foot base 40 is shown in a triangular configuration other shapes and sizes are contemplated including but not limited to round, square, pentagonal and octagonal. In the configuration shown, the jack is a simple scissor jack 42, but other types of jacks are contemplated. The jack 42 secures the lifting crank 43. The lifting crank is placed into the receiver 44 of the jack and turned to extend the top pad 45 of the jack that is placed under the vehicle that is being lifted.

A pair of universal clamps 46 is shown mounted on top of the foot base 40. The universal clamps 46 are used to secure a shovel or other equipment that might be required to jack the vehicle to change a tire 30. The plate of the foot base 40 has a plurality of holes 50 and slots 51 to secure the jack 42, clamps 46 and other equipment. In FIG. 6 the back (mounting) side of the universal spare tire and accessory mount is shown with the back second foot base 60 that connects through straps 25 to the front foot base 40.

Thus, specific embodiments of a universal spare tire and accessory mount have been disclosed. It should be apparent, however, to those skilled in the art that many more modifications besides those described are possible without departing from the inventive concepts herein. The inventive subject matter, therefore, is not to be restricted except in the spirit of the appended claims.

1. A universal spare tire and accessory mount comprising:
a jack;
said jack is secured to a plate to create an enlarged foot base;
said enlarged foot base having an outer tubular frame secured to said plate and further having an inner cap that is located at the same elevation as said outer tubular frame;
said enlarged foot base further having a plurality of openings for securing a flexible strap therein;
said foot base is configured and affixes to a tire, and
thereby allowing said foot base and said jack to be secured with said flexible straps to a vehicle.

2. The universal spare tire and accessory mount according to claim 1 wherein said enlarged foot base is essentially triangular.

3. The universal spare tire and accessory mount according to claim 1 wherein said securing is on an essentially horizontal surface.

4. The universal spare tire and accessory mount according to claim 1 wherein said enlarged foot base is rectangular, round, pentagonal, or octagonal.

5. The universal spare tire and accessory mount according to claim 1 wherein said flexible straps are made from nylon, silk, cotton, polyester or a combination thereof.

6. The universal spare tire and accessory mount according to claim 1 wherein said enlarged foot base further included a plurality of holes and or slots.

7. The universal spare tire and accessory mount according to claim 1 wherein said jack is a scissor jack, a hydraulic jack, a bumper jack or other vehicle lifting device.

8. The universal spare tire and accessory mount according to claim 1 wherein said outer tubular frame is round or square in cross section.

9. The universal spare tire and accessory mount according to claim 1 that further includes at least one universal clamp.

10. The universal spare tire and accessory mount according to claim 1 wherein said plurality of opening for securing a flexible strap exist at corners of said plate.

11. The universal spare tire and accessory mount according to claim 1 wherein said plurality of openings for securing a flexible strap exist at a side of said plate.

12. The universal spare tire and accessory mount according to claim 1 that further includes mounting hardware for mounting said hardware on a vehicle.

13. The universal spare tire and accessory mount according to claim 1 that further includes at least one ratchet buckle.

14. The universal spare tire and accessory mount according to claim 1 that further includes a second enlarged foot base.

15. The universal spare tire and accessory mount according to claim 14 wherein said second enlarged foot base has securing features for mounting said second foot base on a vehicle.

16. The universal spare tire and accessory mount according to claim 14 wherein said second enlarged foot base further include a center post for mounting said tire.

17. The universal spare tire and accessory mount according to claim 14 that further includes mounting hardware for mounting said second enlarged foot base on a vehicle.

18. The universal spare tire and accessory mount according to claim 17 wherein said mounting hardware mounts said second enlarged foot base on a vertical surface.

19. The universal spare tire and accessory mount according to claim 14 wherein said second enlarged foot base includes a plurality of openings located on the periphery of said second enlarged foot base.

20. The universal spare tire and accessory mount according to claim 19 wherein said flexible straps secure said tire between said first and said second enlarged foot base by securing said tire with said flexible straps through said openings of first enlarged foot base and said second enlarged foot base.
